(19) United States
(12) Patent Application Publication
(10) Pub. No.: US 2017/0127102 A1
(43) Pub. Date: May 4, 2017

(54) METHOD AND ELECTRONIC DEVICE FOR VIDEO RECOMMENDATION

(71) Applicants: Le Holdings (Beijing) Co., Ltd., Beijing (CN); Lemobile Information Technology (Beijing) Co., Ltd, Beijing (CN)

(72) Inventor: Junkai YIN, Beijing (CN)

(21) Appl. No.: 15/246,545

(22) Filed: Aug. 25, 2016

Related U.S. Application Data
(63) Continuation of application No. PCT/CN2016/086084, filed on Jun. 16, 2016.

(30) Foreign Application Priority Data
Oct. 30, 2015 (CN) 2015107328990

(51) Int. Cl. H04N 21/25; H04N 21/482; H04N 21/442; H04N 21/258; H04N 21/45; H04N 21/414; H04N 21/475

(52) U.S. Cl. CPC H04N 21/251; H04N 21/41407; H04N 21/4826; H04N 21/4755; H04N 21/25891; H04N 21/4532; H04N 21/44218; H04N 21/44222

(57) ABSTRACT

The present invention discloses a method and electronic device for video recommendation. The method for video recommendation includes: collecting a device usage habit and interesting contents of a user, and acquiring video information associated with the device usage habit and the interesting contents; dividing the video information into multiple classes of video recommendation information according to a preset classification rule, the video recommendation information comprising an introduction, a name and/or a poster of a video; and pushing a video recommendation information prompt containing the multiple classes of video recommendation information to a user, and displaying the video recommendation information prompt at a preset position on the screen of a mobile phone of the user. According to the present invention, videos with personalized preferences can be automatically recommended to different users according to personal preferences of usage habits, interesting contents and the like of the users.

### CROSS REFERENCE TO RELATED APPLICATIONS

The present application is a continuation of International Application No. PCT/CN2016/086084, filed on Jun. 16, 2016 which is based upon and claims priority to China Patent Application No. 201510732899.0 filed on 30 Oct. 2015 with the title of “mobile phone screen based video recommendation method and system”, the entire contents of which are incorporated herein for all purposes by this reference.

### TECHNICAL FIELD

The present invention relates to the technical field of information technology, and specifically relates to a method and electronic device for video recommendation.

### BACKGROUND

Nowadays, under the background of the continuous development of information technology, smart phones used by people become more and more personalized and application functions are also increasingly strong. A smart phone, like a personal computer, has become an intelligent device which has an independent operating system and an independent operation space. Such smart phone can allow users to install programs provided by third-party service providers, such as software, games, navigation and the like, by themselves, and can acquire network access through a mobile communication network.

The smart phone has become one of the main ways for most users to watch video programs. A user, firstly, unlocks a screen, (such as the mobile phone screen shown in FIG. 1), then turns on a corresponding video player (for example, a LeTV client) on the smart phone to find an interesting video, and clicks in to play the video, so that the user can enjoy watching videos anytime and anywhere in connection with the Internet.

However, in the above-mentioned prior art, users need to manually find videos of their own interests/preferences, and then play the videos. The process of finding always consumes the users lots of time and energy; and since the video programs on the network are updated all the time, users may need to keep abreast of the latest video programs. Therefore, the prior art is lack of a method capable of actively recommending video programs with personalized preferences for the users.

### SUMMARY

In order to solve the technical problem in the prior art that personalized video recommendation cannot be implemented on the screen of a mobile phone of a user, the present invention provides a method and electronic device for video recommendation.

The method for video recommendation according to an embodiment of the present invention may include: collecting a device usage habit and interesting contents of a user, and acquiring video information associated with the device usage habit and the interesting contents; dividing the video information into multiple classes of video recommendation information according to a preset classification rule, the video recommendation information comprising introduction, name and/or poster of a video; and pushing a video recommendation information prompt containing the multiple classes of video recommendation information, to a user, and displaying the video recommendation information prompt at a preset position on the screen of a mobile phone of the user.

In another aspect, an electronic device for application program recommendation according to an embodiment of the present invention includes: at least one processor; and a memory communicably connected with the at least one processor for storing instructions executable by the at least one processor. The execution of the instructions by the at least one processor causes the at least one processor to: collect a device usage habit and interesting contents of a user, and acquire video information associated with the device usage habit and the interesting contents; divide the video information into multiple classes of video recommendation information according to a preset classification rule, the video recommendation information comprising introduction, name and/or poster of a video; and push, to a user, a video recommendation information prompt containing the multiple classes of video recommendation information, and display the video recommendation information prompt at a preset position on the screen of a mobile phone of the user.

In yet another embodiment of the present invention, a non-transitory computer-readable storage medium is provided. The storage medium stores executable instructions that, when executed by an electronic device, cause the electronic device to: collect a device usage habit and interesting contents of a user, and acquire video information associated with the device usage habit and the interesting contents; divide the video information into multiple classes of video recommendation information according to a preset classification rule, the video recommendation information comprising introduction, name and/or poster of a video; and push, to a user, a video recommendation information prompt containing the multiple classes of video recommendation information, and display the video recommendation information prompt at a preset position on the screen of a mobile phone of the user.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a display image without video recommendation information on the mobile phone screen in the prior art;

FIG. 2 is a work flow diagram of the embodiment I of the present invention;

FIG. 3 is a schematic diagram of the video recommendation information prompt displayed on the mobile phone screen according to the present invention;

FIG. 4 is a schematic diagram of the video recommendation information prompt and the video recommendation information of the videos of the first class displayed on the mobile phone screen according to the present invention;

FIG. 5 is a schematic diagram of the video recommendation information prompt, the video recommendation information of the videos of the first class and the video recommendation information of the videos of the second class displayed on the mobile phone screen according to the present invention;

FIG. 6 is a schematic diagram of the structure of a device in the embodiment II of the present invention; and

FIG. 7 is a block diagram of an electronic device which can implement the method for video recommendation according to the present invention.

### DETAILED DESCRIPTION

Hereinafter, with reference to the accompanying drawings, the specific embodiments of the present invention are described in details, and it will be appreciated that the protection scope of the present invention is not limited by the specific embodiments.

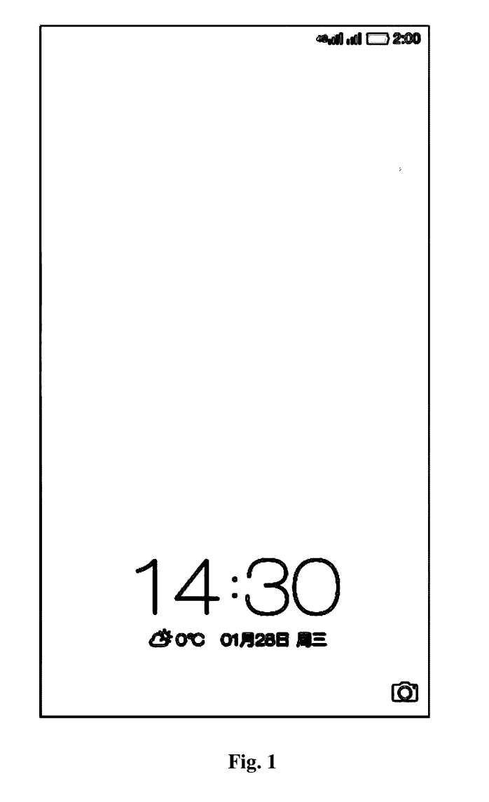

In order to solve the technical problem in the prior art that personalized video recommendation cannot be implemented on the screen of a mobile phone of a user, the present invention provides a method, system and .electronic device for video recommendation. As shown in FIG. 1, in the prior art, the mobile phone screen has no display image of video recommendation information.

### Embodiment I

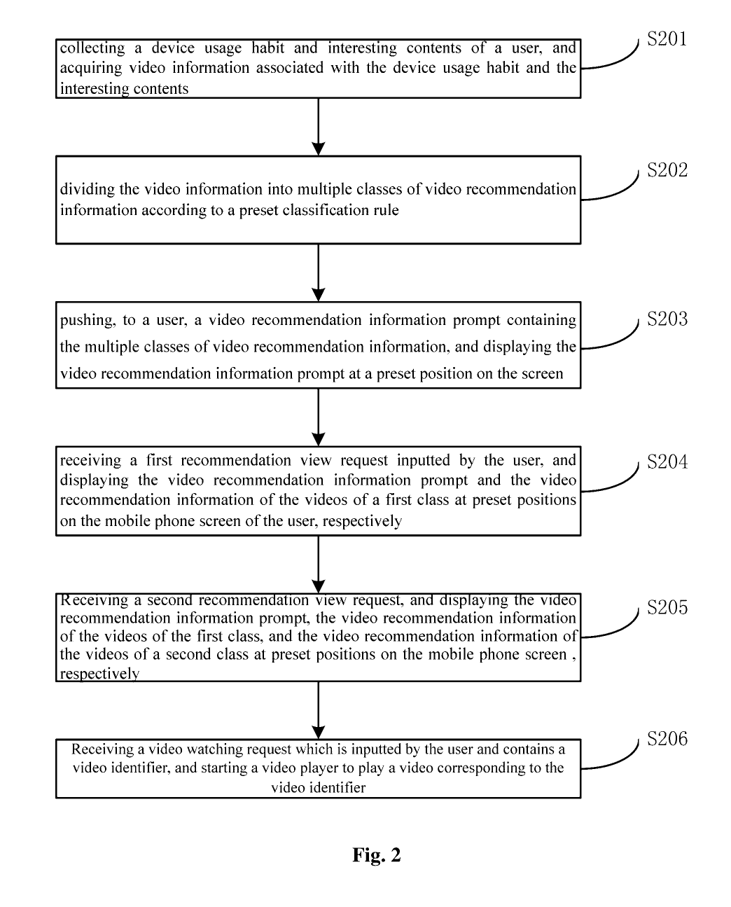

As shown in FIG. 2, a method for video recommendation includes the following steps:

S201: collecting a device usage habit and interesting contents of a user, and acquiring video information associated with the device usage habit and the interesting contents.

Specifically, the preference information of the user only can be obtained after the user logs on a corresponding account (e.g., an account of a LeTV phone), for example, according to a wallpaper, a favorite star or a latest video preview frequently clicked in and the like set on the screen of the mobile phone of the user, searching all video information related to the wallpaper, the star or the preview.

S202: dividing the video information into multiple classes of video recommendation information according to a preset classification rule, the video recommendation information comprising the introduction, name and/or poster of a video.

The preset classification rule may involve multiple classes of movies, TV plays, variety shows and the like, and each class comprises information of introductions, names and/or posters of a plurality of videos.

S203: pushing a video recommendation information prompt containing the multiple classes of video recommendation information to a user, and displaying the video recommendation information prompt at a preset position on the screen of a mobile phone of the user.

The video recommendation information prompt may be pushed to the user according to the recommendation time and/or the number of times of recommendation preset by the user, for example, pushed to the user once at 18:00 every day.

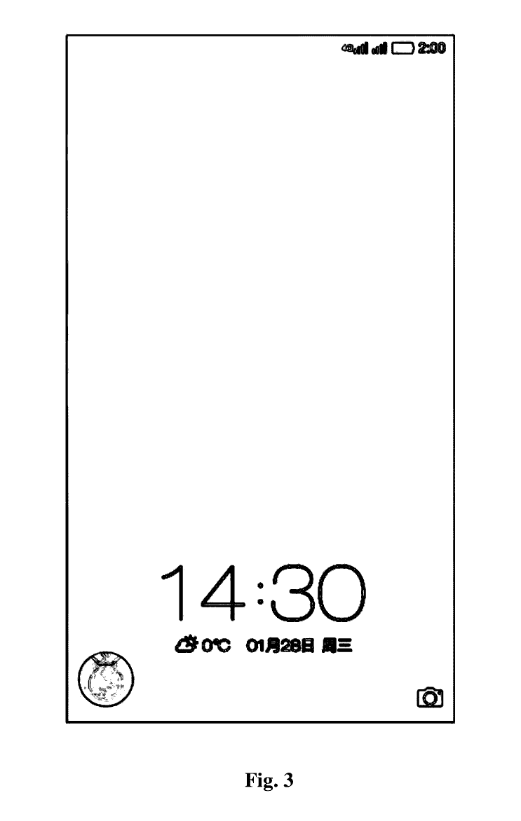

As shown in FIG. 3, an icon of a video recommendation information prompt is displayed at the lower-left corner of the mobile phone screen.

S204: receiving a first recommendation view request input by the user, and displaying the video recommendation information prompt and the video recommendation information of the videos of a first class at preset positions on the mobile phone screen of the user respectively.

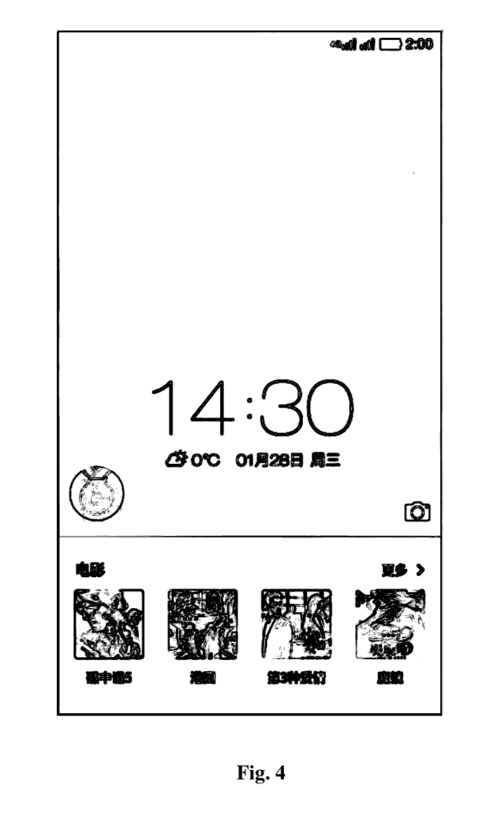

As shown in FIG. 4, an icon of a video recommendation information prompt and video recommendation information of a movie class are displayed at the lower-left corner of the mobile phone screen.

S205: receiving a second recommendation view request inputted by the user, and displaying the video recommendation information prompt, the video recommendation information of the videos of the first class and the video recommendation information of the videos of a second class at preset positions on the mobile phone screen of the user respectively.

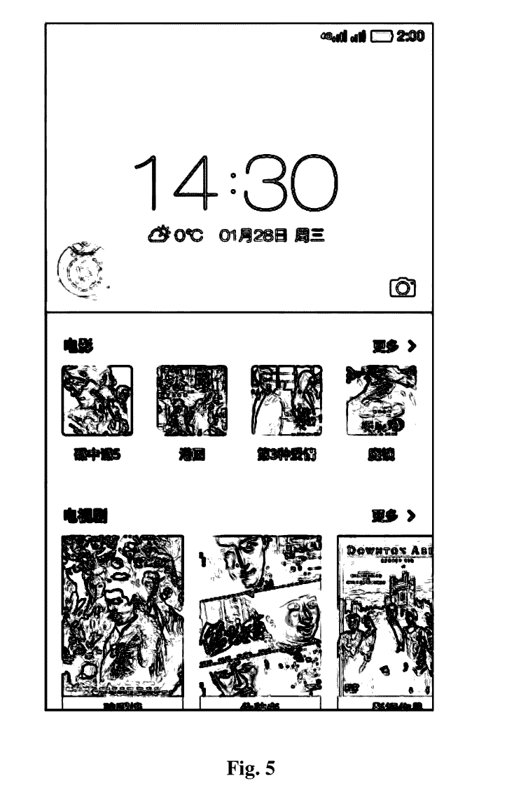

As shown in FIG. 5, the icon of the video recommendation information prompt, the video recommendation information of a movie class and video recommendation information of a TV play class are displayed at the lower-left corner of the mobile phone screen. It will be appreciated by those skilled in the art that more classes of video recommendation information can also be set according to the present invention and displayed for users, and the displaying processes such as S204 or S205 are not described in details herein.

The recommendation view requests described in the steps S204-S205 may be operations of swiping upward and the like, and it will be appreciated by those skilled in the art that the operation mode of the recommendation view requests may be set by oneself.

S206: receiving a video watching request input by the user containing a video identifier, and starting a video player to play a video corresponding to the video identifier.

The recommended video information includes introductions, names and/or posters and the like of multiple classes of videos of movie, TV play, variety show and the like, and if a user wants to play a certain video, the user only needs to click in the video and then the system automatically starts a corresponding video player (e.g., a LeTV client) to play the video.

According to the method and electronic device for video recommendation disclosed by the present invention, videos with personalized preferences can be automatically recommended to different users according to personal preferences of usage habits, interesting contents and the like of the users, so that the users do not have to spend a lot of time in finding videos they want to watch, thereby saving the time for the users to find and play videos, optimizing the work flow of finding and watching videos, providing a more accurate video view and play platform, and improving the user experience.

### Embodiment II

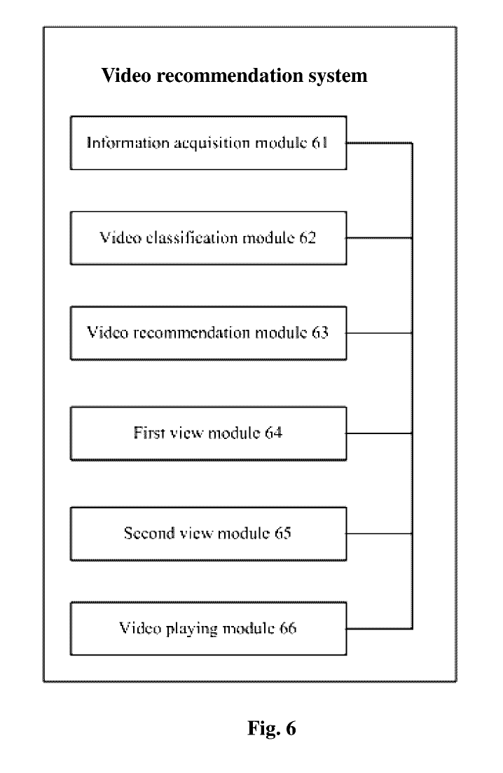

As shown in FIG. 6, the video recommendation system comprises: an information acquisition module 61, which is used for collecting a device usage habit and interesting contents of a user, and acquiring video information associated with the device usage habit and the interesting contents; a video classification module 62, which is used for dividing the video information into multiple classes of video recommendation information according to a preset classification rule, the video recommendation information comprising the introduction, name and/or poster of a video; and a video recommendation module 63, which is used for pushing a video recommendation information prompt containing the multiple classes of video recommendation information to a user, and displaying the video recommendation information prompt at a preset position on the screen of a mobile phone of the user.

In a possible embodiment, the system also comprises: a first view module 64, which is used for receiving a first recommendation view request input by the user, and displaying the video recommendation information prompt and the video recommendation information of the videos of a first class at preset positions on the mobile phone screen of the user respectively; and a second view module 65, which is used for receiving a second recommendation view request input by the user, and displaying the video recommendation information prompt, the video recommendation information of the videos of the first class and the video recommendation information of the videos of a second class at preset positions on the mobile phone screen of the user respectively.

In a possible embodiment, the second view module 65 is used for pushing the video recommendation information prompt containing the multiple classes of video recommendation information to the user according to the recommendation time and/or the number of times of recommendation preset by the user, and displaying the video recommendation information prompt at a preset position on the mobile phone screen of the user.

In a possible embodiment, the system also comprises: a video playing module 66 used for receiving a video watching request which is input by the user and contains a video identifier, and starting a video player to play a video corresponding to the video identifier.

The video recommendation system disclosed by the present invention can automatically recommend videos with personalized preferences to different users according to personal preferences of usage habits, interesting contents and the like of the users, so that the users do not have to spend a lot of time in finding videos they want to watch, thereby saving the time for the users to find and play videos, optimizing the work flow of finding and watching videos, providing a more accurate video view and play platform, and improving the user experience.

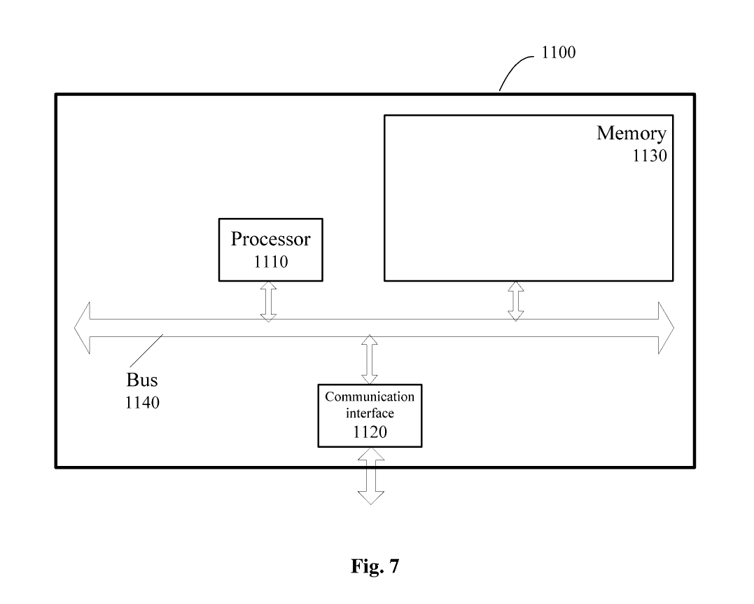

FIG. 7 is a block diagram of an electronic device which can implement the method for video recommendation according to the present invention. The electric device 1100 may be a host server, a personal computer (PC), or a portable computer or terminal and the like with computing power. The specific embodiments of the present invention do not limit concrete implementation of computing nodes.

The electronic device 1100 comprises a processor 1110, a communications interface 1120, a memory (memory array) 1130 and a bus 1140, wherein the processor 1110, the communications interface 1120 and the memory 1130 communicate with one another through the bus 1140.

The communications interface 1120 is used for communicating with a network element, wherein the network element comprises, for example, a virtual machine management center, shared storage and the like.

The processor 1110 is used for executing programs. The processor 1110 may be a central processing unit (CPU), or an ASIC (Application Specific Integrated Circuit), or one or more integrated circuits configured to implement the embodiments of the present invention.

The memory 1130 is used for storing files. The memory 1130 may comprise a high-speed RAM memory, and may also comprise a non-volatile memory, for example, at least one disk memory. The memory 1130 also can be a memory array. The memory 1130 may also be partitioned into blocks, and the blocks can be combined into a virtual volume according to a certain rule.

In a possible embodiment, the above-mentioned programs may be program codes comprising computer operating instructions, causes the at least one processor to: collect a device usage habit and interesting contents of a user, and acquire video information associated with the device usage habit and the interesting contents; divide the video information into multiple classes of video recommendation information according to a preset classification rule, the video recommendation information comprising introduction, name and/or poster of a video; and push, to a user, a video recommendation information prompt containing the multiple classes of video recommendation information, and display the video recommendation information prompt at a preset position on the screen of a mobile phone of the user.

In a possible embodiment, execution of the instructions by the at least one processor further causes the at least one processor to: receive a first recommendation view request inputted by the user, and display the video recommendation information prompt and the video recommendation information of the videos of a first class at preset positions on the mobile phone screen of the user, respectively; and receive a second recommendation view request inputted by the user, and display the video recommendation information prompt, the video recommendation information of the videos of the first class, and the video recommendation information of the videos of a second class at preset positions on the mobile phone screen of the user, respectively.

In a possible embodiment, execution of the instructions by the at least one processor further causes the at least one processor to: receive a video watching request which is inputted by the user and which contains a video identifier, and start a video player to play a video corresponding to the video identifier.

Another embodiment of the present invention provides a non-transitory computer-readable storage medium storing executable instructions that, when executed by an electronic device, cause the electronic device to implement the video recommendation method described in various embodiments of the present invention.

It will be appreciated by those skilled in the art that the embodiments of the present invention can provide a method, a system, or a computer program product. Therefore, the present invention can adopt a form of full-hardware embodiments, full-software embodiments, or embodiments with combination of hardware and software. Moreover, the present invention can adopt a form of the computer program product implemented on one or more computer-available storage media (including but not limited to a disk memory and an optical memory, etc.) containing computer-available program codes.

The present invention may have various embodiments in different forms, the embodiments of the present invention is illustrated above by taking FIG. 1-FIG. 6 as examples with reference to the accompanying drawings, and this does not mean that the specific examples applied by the present invention can only be limited to specific processes or an embodiment structure; and it will be appreciated by those skilled in the art that the above-mentioned specific embodiments are just some examples of a variety of preferred usages, and any embodiment embodying the claims of the present invention shall be in the scope claimed by the technical solution of the present invention.

Finally, it should be explained that: what mentioned above are only preferred embodiments of the present invention, and are not used for limiting the present invention; and although the present invention is described in details with reference to the above-mentioned embodiments, those skilled in the part still can modify the technical solution recorded by the above-mentioned embodiments, or equivalently replace part of the technical characteristics therein. Within the spirit and principle of the present invention, any modification, equivalent replacement, improvement, etc., shall be included in the protection scope of the present invention.

What is claimed is:

1. A method for video recommendation, used at an electronic terminal, said method comprising:
collecting a device usage habit and interesting contents of a user, and acquiring video information associated with the device usage habit and the interesting contents;
dividing the video information into multiple classes of video recommendation information according to a preset classification rule, the video recommendation information comprising introduction, name and/or poster of a video; and
pushing, to a user, a video recommendation information prompt containing the multiple classes of video recommendation information, and displaying the video recommendation information prompt at a preset position on the screen of a mobile phone of the user.

2. The method according to claim 1, further comprising:
receiving a first recommendation view request inputted by the user, and displaying the video recommendation information prompt and the video recommendation information of the videos of a first class at preset positions on the mobile phone screen of the user, respectively; and
receiving a second recommendation view request inputted by the user, and displaying the video recommendation information prompt, the video recommendation information of the videos of the first class, and the video recommendation information of the videos of a second class at preset positions on the mobile phone screen of the user, respectively.

3. The method according to claim 1, wherein the video recommendation information prompt containing the multiple classes of video recommendation information is pushed to the user according to a recommendation time and/or the number of times of recommendation preset by the user, and the video recommendation information prompt is displayed at a preset position on the mobile phone screen of the user.

4. The method according to claim 1, further comprising:
receiving a video watching request which is inputted by the user and which contains a video identifier, and starting a video player to play a video corresponding to the video identifier.

5. An electronic device for video recommendation, comprising:
at least one processor; and
a memory communicably connected with the at least one processor for storing instructions executable by the at least one processor, wherein execution of the instructions by the at least one processor causes the at least one processor to:
collect a device usage habit and interesting contents of a user, and acquire video information associated with the device usage habit and the interesting contents;
divide the video information into multiple classes of video recommendation information according to a preset classification rule, the video recommendation information comprising introduction, name and/or poster of a video; and
push, to a user, a video recommendation information prompt containing the multiple classes of video recommendation information, and display the video recommendation information prompt at a preset position on the screen of a mobile phone of the user.

6. The electronic device according to claim 5, wherein execution of the instructions by the at least one processor further causes the at least one processor to:
receive a first recommendation view request inputted by the user, and display the video recommendation information prompt and the video recommendation information of the videos of a first class at preset positions on the mobile phone screen of the user, respectively; and
receive a second recommendation view request inputted by the user, and display the video recommendation information prompt, the video recommendation information of the videos of the first class, and the video recommendation information of the videos of a second class at preset positions on the mobile phone screen of the user, respectively.

7. The electronic device according to claim 5, wherein the video recommendation information prompt containing the multiple classes of video recommendation information is pushed to the user according to a recommendation time and/or the number of times of recommendation preset by the user, and the video recommendation information prompt is displayed at a preset position on the mobile phone screen of the user.

8. The electronic device according to claim 5, wherein execution of the instructions by the at least one processor further causes the at least one processor to:
receive a video watching request which is inputted by the user and which contains a video identifier, and start a video player to play a video corresponding to the video identifier.

9. A non-transitory computer-readable storage medium storing executable instructions that, when executed by an electronic device, cause the electronic device to:
collect a device usage habit and interesting contents of a user, and acquire video information associated with the device usage habit and the interesting contents;
divide the video information into multiple classes of video recommendation information according to a preset classification rule, the video recommendation information comprising introduction, name and/or poster of a video; and
push, to a user, a video recommendation information prompt containing the multiple classes of video recommendation information, and display the video recommendation information prompt at a preset position on the screen of a mobile phone of the user.
